(19) United States
(12) Patent Application Publication
(10) Pub. No.: US 2007/0290788 A1
(43) Pub. Date: Dec. 20, 2007

(54) Method for Configuration of an Electrical Field Device, and a Configurable Electrical Field Device

(75) Inventor: Ingo Erkens, Altdorf-Grunsberg (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/659,415

(22) PCT Filed: Jul. 19, 2005
(86) PCT No.: PCT/EP05/53476

§ 371 Date: Feb. 5, 2007

(30) Foreign Application Priority Data
Aug. 4, 2004 (DE) 102004038306.5

(51) Int. Cl. G05B 23/02

(52) U.S. Cl. 340/3.1

(57) ABSTRACT

A method configures an electrical field device that has a control unit with selection switches arranged on it. Selection switch settings are detected by the control unit for the electrical field device as a configuration number. The control unit uses a table, which is stored in a memory for the field device, to determine the device settings associated with the configuration number which describes the settings and the selection switches, for the electrical field device, and sets these, thus completing the configuring of the electrical field device.

The invention relates to a method for configuration of an electrical field device, with the field device having a control unit with selection switches arranged on it, and to a configurable electrical field device of this type.

Electrical field devices are used in particular for automation of power supply installations, such as electrical power supply systems, as well as for engineering processes and industrial automation. In order to allow field devices such as these to carry out the desired functions, they must be configured during their setting-up process, that is to say specific device functions must be set, and setting must be refined, for example for threshold values and operating parameters. Settings such as these will be referred to for short in the following text as device settings.

An electrical field device in the form of a digital overcurrent-time protected device for power supply systems, which has a control unit with control switches arranged on it in the form of so-called DIP switches (DIP=Dual Inline Package), that is to say switches with connections arranged in two rows, is known from the “Design” and “Settings” chapters in the Siemens Device Manual “SIPROTEC EASY: Digitaler Überstromzeitschutz 7SJ45” [7SJ45 Digital overcurrent—time production], Order No. C53000-K1174-C001-7, in particular pages 9-16. Specific functions are permanently associated with each of the total of 30 DIP switches by means of an inscription on the control panel of the overcurrent-time protected device. By way of example, the electrical overcurrent-time protected device can be selectively matched to an electrical power supply system at a frequency of 50 or 60 Hz by movement of one of the DIP switches. Further DIP switches determine the operating mode of the overcurrent-time protected device, and define various limit values, for example for current thresholds or delay times. The visually and circuitry fixed association between individual device functions and their corresponding DIP switches limits the number of switch combinations which can be sensibly set on the device—and thus also the number of device functions which can be set. Thus, for example, a number of switch combinations are mutually exclusive with regard to the choice of the operating mode.

The invention is now based on the object of providing a method and a field device of the type mentioned above in which a comparatively large number of functions of the electrical field device can be configured, despite said electrical field device having a simple design.

According to the invention, this object is achieved by a method of the indicated type in which selection switch settings that are made are detected by a control unit for the electrical field device as a configuration number, and the control unit uses a table, which is stored in a memory for the field device to determine the device settings associated with the configuration number which describes the settings and the selection switches, for the electrical field device, and sets these, thus completing the configuration of the electrical field device. The advantage of the method according to the invention is that there is no fixed association between a respective selection switch and a corresponding device setting, but, in fact, a corresponding configuration of the electrical field device can be associated with any desired input, as made by means of the selection switches, of a configuration number. The increase in the number of combination options which can be set in the selection switches in this case increases the configurable functional scope of the electrical field device by several times compared with the fixed association between individual switches and individual device functions.

One embodiment of the method according to the invention which is particularly simple provides for multipole position switches to be used as selection switches. In this case, by way of example, the design of the control unit, which is known from the overcurrent-time protected device mentioned above, and has a number of selections which is in the form of DIP switches, can be largely transferred. However, there is no permanent visual association by means of an inscription associated with the switches on the control unit. The configuration number set on the selection switches is in this case detected by the control unit for the electrical field device. Even a six-pole control switch, comprising six individual DIP switches, in this case results in a possible total number of 2⁶=64 combination options. The number of combination options increases in a corresponding manner when further control switches are used.

Alternatively, it is also possible to provide for keys on a keypad to be used as selection switches. In this case, just one keypad with number keys, on which any desired configuration numbers can be entered, must be provided on the control surface of the electrical field device. The number of possible combinations is in this case restricted only by the length of the configuration number that is entered.

In a further advantageous embodiment of the method according to the invention, the device settings which are associated with the configuration number are displayed on a display device for the electrical field device. This allows the device settings selected by means of the configuration number to be displayed in a simple form.

Alternatively, however, it is also possible to provide for the device settings which are associated with the configuration number to be displayed by means of light elements on the electrical field device, with in each case one device setting being associated with the individual light elements on the field device by means of an inscription. In this case, the possible device settings would, for example, be listed on the control panel of the electrical field device and would be marked by means of light elements such as light-emitting diodes, dependent on the device setting selected by means of the configuration number. This also allows the selected device settings to be displayed in a simple and low-cost form.

Furthermore, one advantageous embodiment of the method according to the invention provides for the configuration number which corresponds to the selection switch settings to be made by means of a data processing device from predetermined function settings for the electrical field devices. This allows the configuration number to be entered to be determined very easily with the aid of configuration software which is installed in a data processing installation, specifically by the operator of the electrical field device presetting desired device function settings and by the configuration software using this to determine the appropriate configuration number to be set.

According to a further advantageous embodiment of the method according to the invention, it is also possible to provide in this context, when control switches are used as the selection switches, for the data processing device to display a switch combination, which corresponds to the configuration number, on a display apparatus, or to output this as a printout. This means that the configuration number to be set on the field device is in fact output in an easily comprehensible and clear manner in the form of a graphical display of the switch combination to be transferred to the device.

The object mentioned above is also achieved by means of a configurable electrical field device having control switches, which are arranged on a control unit, in which the control unit has a display apparatus for displaying device settings, which are associated with the entered configuration number for the electrical field device. Specifically, in the case of a field device such as this there is no longer any fixed visual and circuitry association between the individual device functions and the individual control switches but, in fact, the configuration number which can be entered on the control switches makes it possible to define virtually any desired number of any desired functions of the field device in the form of configurable device settings. The operator of the electrical field device can accordingly use the display apparatus to read the desired device settings conveniently and clearly.

Furthermore, the object mentioned above is also achieved by a configurable electrical field device having control switches, which are arranged on a control unit, in the case of which the control unit has light elements for indication of device settings which are associated with an entered configuration number for the electrical field device with one device setting being associated with each of the light elements by means of an inscription. In this case, the device settings can be made visible clearly by means of a comparatively low-cost indication, specifically by means of the light elements—for example light-emitting diodes.

For further explanation:

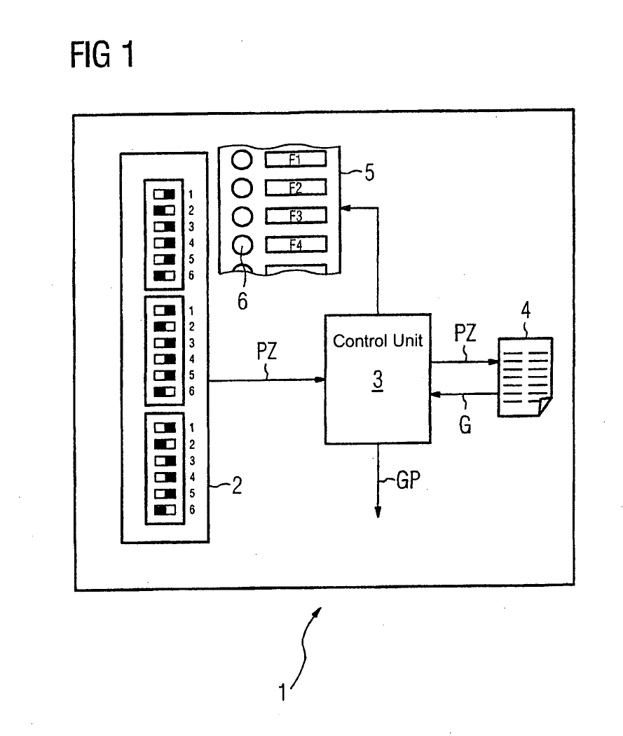

FIG. 1 shows, schematically a first exemplary embodiment of a method for configuration of an electrical field device,

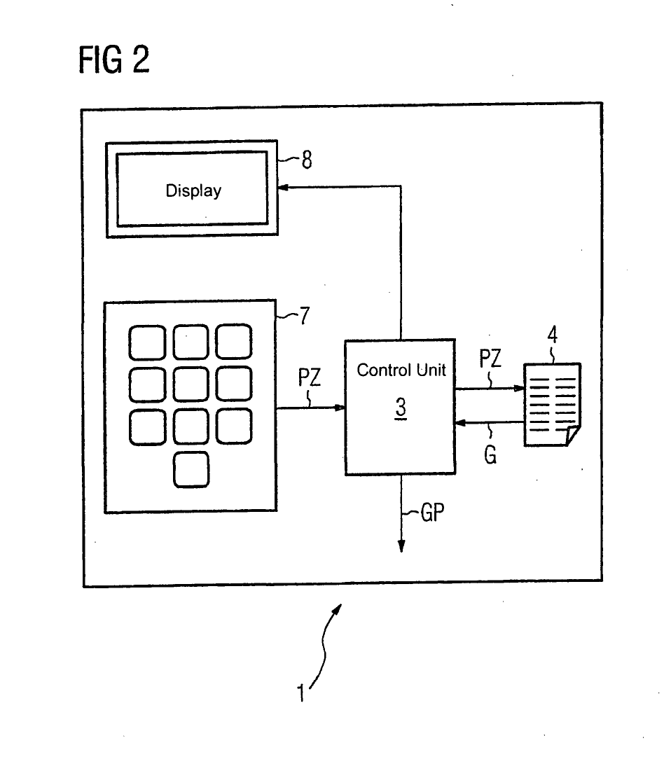

FIG. 2 shows, schematically, a further exemplary embodiment of a method for configuration of an electrical field device, and

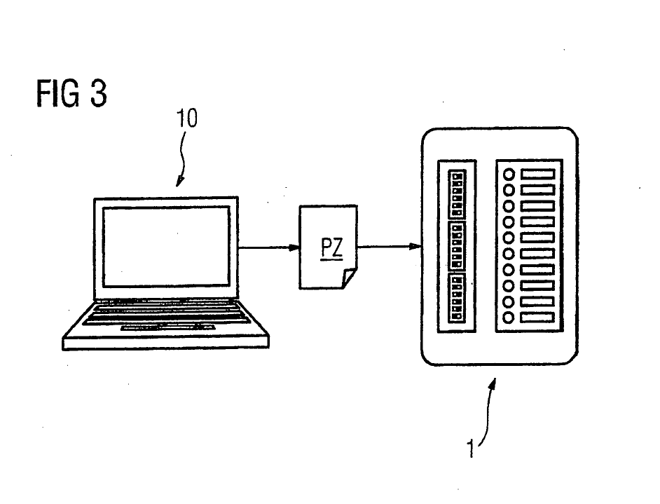

FIG. 3 shows a schematic illustration in order to explain how a configuration number is determined.

FIG. 1 shows, schematically, an electrical field device 1, in which case the illustration shown in FIG. 1 in fact indicates functional blocks in order to explain the configuration method, rather than providing a detailed illustration of the electrical field device. The electrical field device 1 has a control unit with selection switches 2, which is indicated in FIG. 1 in the form of control switches or so-called DIP switches. The position of the selection switches 2 can be checked via a control unit 3 for the electrical field device 1. A table 4 for access by the control unit 3 is stored in a memory for the field device 1.

In order to configure the field device 1, the operator of the electrical field device 1 must enter a switch combination, which in the end indicates a configuration number PZ on the control switches while setting up the electrical field device 1. For this purpose, three six-pole control switches are provide in FIG. 1, with the numbers 1 to 6 being respectively associated with the individual poles of the control switches. In order to set a configuration number on the control switches, the respective pole of the control switch must be moved to a switched-on position (by way of example, in FIG. 1, the position shifted to the right corresponds to the switched-on position). By way of example, the number “1 3 4 5 1 5 1 3 4 5” has been set as the configuration number PZ in FIG. 1. This configuration number PZ is read by the control unit 3 on the selection switches 2 and is compared with the Table 4. Specifically, respectively associated device settings G are associated with corresponding configuration numbers PZ on the basis of Table 4. The control unit 3 now therefore searches for device settings associated with the corresponding configuration numbers PZ, from the Table 4 and then uses the device setting to set the device configuration GP as is indicated by the arrow GP in FIG. 1. In this example, for instance, the configuration number “1 3 4 5 1 5 1 3 4 5” may be associated with a setting which, for example, associates the field device with an operating frequency of 50 Hz, defines the operating mode of the field device, for example as independent overcurrent-time protection and defines appropriate setting values for threshold values, for example, current threshold values. All of the desired functions of the field device 1 are thus configured by entering a single configuration number.

The provision of a correspondingly large number of multipole control switches makes it possible to enter virtually any desired number of device settings. Purely by calculation, even a single six-pole control switch allows a total of 2⁶=64 possible switch combinations, and thus a total of 64 different device configurations. Two six-pole control switches allow even more than 4000 possible combinations for device configuration. The total number increases in a corresponding manner as further multipole control switches are added. In this case, the multipole control switches need not be restricted to a total of six poles and, in fact it is also possible to use control switches with different numbers of poles.

In order to allow the selected device configuration to additionally be made visible to the operator of the field device on the field device itself, FIG. 1 shows, for example, an indication block 5 which has light elements in the form of light-emitting diodes 6. Each light-emitting diode 6 is associated with a corresponding device setting in a function field—by way of example four function fields F1 to F4 are shown in FIG. 1. By way of example, the first function field F1 may have the inscription “50 Hz” as a possible setting for the electrical field device. If the frequency is now set in accordance with Table 4 at 50 Hz by means of the configuration number PZ, then the light-emitting diode associated with the first function field F1 is actuated, and visibly marks this device setting on the device. The second function field F2 may, for example, indicate a frequency selection of 60 Hz by means of a corresponding inscription; if this frequency is selected by means of the configuration number PZ, then the light-emitting diode for the second function field F2 will illuminate instead of the light-emitting diode in the first function field F1.

All of the possible device settings of the electrical field device can be indicated in a corresponding manner in an indication block 5 such as this (in consequence, the indication block 5 need not be restricted to the four function fields F1 to F4 shown here, with corresponding light-emitting diodes), so that all of the selected device settings can always be visibly identified from the outside. Since an ever greater number of device settings are always defined at the same time by a single configuration number, an ever greater number of the function fields provided are normally always marked.

FIG. 2 shows an alternative embodiment of a method for configuration of a field device 1. The method shown in FIG. 2 differs from the method explained with reference to FIG. 1, inter alia in that the configuration number PZ is in this case not entered via multipole control switches but by means of a keypad 7 with individual keys. In this case, the control unit 3 in each case reads the configuration number PZ set on the keypad 7, and once again compares this with device settings G stored in the Table 4, which are read, corresponding to the respective configuration number PZ, from the Table 4, and are used as the device configuration GP.

A further difference from the method shown in FIG. 1 is indicated in FIG. 2 by the fact that the device settings selected by means of the configuration number PZ are now shown on a display, for example, an LCD display 8. Configuration numbers PZ of any desired length can be entered via the keypad 7 and any desired number of device settings can be indicated on the display 8.

Finally, FIG. 3 shows one possible way to produce the configuration number PZ that is required for device configuration. For example, in this case, the operator of the electrical field device 1 can select the desired device functions for the electrical field device 1 by means of configuration software which is installed in a data processing device 10, whilst setting up the electrical field device. In this case, for example, the desired functions are marked on a screen view of the configuration software. The configuration software is used to generate an appropriate configuration number PZ from the marked device functions. In other words, a table which is the inverse of the Table 4 in the electrical field device (see FIGS. 1 and 2) is stored in the data processing device 10, and can be accessed by the configuration software. In contrast to the process explained with reference to FIGS. 1 and 2 in which the control unit 3 for the field device 1 selects from the Table 4 the device settings associated with a respective configuration number PZ, an appropriate configuration number PZ is, in the case of the configuration software, read from the inverse table for the corresponding device settings or desired device functions. This can be indicated on a display apparatus, for example, a screen, of the data processing device 10 or can be printed out by means of a printer, which is not shown in FIG. 3, but is connected to the data processing device 10.

The operator of the electrical field device 1 now uses this configuration number PZ—as already explained with reference to FIGS. 1 and 2—to set the desired device configuration on the electrical field device 1.

When using multipole control switches (see FIG. 1) to input the configuration number PZ on the electrical field device 1, a display in the form of an image of the corresponding switch positions can be indicated or printed out, for simplicity, instead of the configuration number PZ. In this case, the operator of the electrical field device now just has to select the switch settings on the control switches for the electrical field device such that they correspond to printed-out representation in the form of an image.

1-9. (canceled)

10. A method for configuring an electrical field device having selection switches, which comprises the steps of:
detecting, via a control unit, selection switch settings made for the electrical field device as a configuration number;
by using a table stored in a memory for the electrical field device, the control unit determining device settings associated with the configuration number describing the selection switch settings and the selection switches of the electrical field device; and
setting the device settings for completing the configuring of the electrical field device.

11. The method according to claim 10, which further comprises providing multipole position switches as the selection switches.

12. The method according to claim 10, which further comprises providing keys on a keypad as the selection switches.

13. The method according to claim 10, which further comprises displaying the device settings, which are associated with the configuration number, on a display device of the electrical field device.

14. The method according to claim 10, which further comprises displaying the device settings associated with the configuration number by light elements on the electrical field device, with in each case one of the device settings being associated with an individual one of the light elements on the field device by an inscription.

15. The method according to claim 10, which further comprises determining the configuration number, which corresponds to the selection switch settings made, by a data processing device from predetermined functional settings for the electrical field device.

16. The method according to claim 15, wherein when control switches are used as the selection switches, the data processing device displays a switch combination corresponding to the configuration number, on a display apparatus, or outputs the switch combination as a printout.

17. A configurable electrical field device, comprising:
a control unit;
control switches for inputting a configuration number and connected to said control unit; and
said control unit having a display apparatus for displaying device settings associated with an entered configuration number for the electrical field device.

18. A configurable electrical field device, comprising:
a control unit;
control switches for inputting a configuration number and connected to said control unit; and
said control unit having light elements for indicating device settings associated with an entered configuration number for the electrical field device with one device setting being associated with each of said light elements by an inscription.
